(19) United States
(12) Patent Application Publication
(10) Pub. No.: US 2012/0094190 A1
(43) Pub. Date: Apr. 19, 2012

(54) ASYMMETRIC AND/OR LOW-SYMMETRIC FLUORINE-CONTAINING PHOSPHATE FOR NON-AQUEOUS ELECTROLYTE SOLUTION

(75) Inventors: Hideyuki Mimura, Yamaguchi (JP); Kentaro Kono, Yamaguchi (JP); Hisao Eguchi, Yamaguchi (JP); Kotaro Sakoda, Yamaguchi (JP); Masahiro Aoki, Yamaguchi (JP)

(73) Assignee: TOSOH F-TECH, INC., Shunan-shi, Yamaguchi (JP)

(21) Appl. No.: 13/380,658

(22) PCT Filed: Jul. 30, 2010
(86) PCT No.: PCT/JP2010/004851

§ 371 Date: Dec. 23, 2011

(30) Foreign Application Priority Data
Aug. 4, 2009 (JP) 2009-181436
Dec. 2, 2009 (JP) 2009-274816

(51) Int. Cl. H01M 10/056; C07F 9/141

(52) U.S. Cl. 429/324; 429/200; 558/204; 558/97

(57) ABSTRACT

As to a fluorine-containing phosphate used to impart flame retardancy to an electrolyte solution for a non-aqueous secondary battery, a fluorine-containing phosphate having high flame retardancy and providing high battery performance such as high-rate charge-discharge characteristics, and a method for manufacturing the same are provided. Also provided are a non-aqueous electrolyte solution and a non-aqueous secondary battery each containing the fluorine-containing phosphate.

Further a fluorine-containing phosphate having a high ability to dissolve an electrolyte and capable of providing the composition of a safer electrolyte solution is provided.

The fluorine-containing phosphate for a non-aqueous electrolyte solution is represented by the general formula (1)

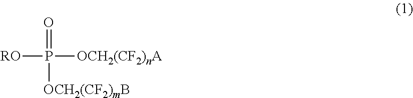

(wherein R represents an alkyl group having 1 to 10 carbon atoms or a fluorine-containing alkyl group having 1 to 10 carbon atoms, A and B are different from each other and each represent a hydrogen atom or a fluorine atom, and n and m each independently represent an integer from 1 to 8) and contains fluorine atoms in a weight ratio of 30% or higher.

### TECHNICAL FIELD

The present invention relates to a fluorine-containing phosphate used as a flame retardant for a non-aqueous electrolyte solution. More particularly, the invention relates to a fluorine-containing phosphate having a specific structure and providing excellent physical properties and characteristics as a non-aqueous electrolyte solution, to a method for manufacturing the same, and to a non-aqueous electrolyte solution and a non-aqueous secondary battery each containing the fluorine-containing phosphate.

### BACKGROUND ART

Non-aqueous secondary batteries have a high power density and a high energy density and are widely used as power sources of mobile phones and personal computers. Such non-aqueous secondary batteries produce clean energy with low carbon dioxide emissions, and active research on their applications to power sources for power storage and power sources for electric automobiles is recently being conducted.

Known examples of the non-aqueous secondary battery include lithium secondary batteries, lithium ion secondary batteries, magnesium secondary batteries, and magnesium ion secondary batteries. For example, in lithium secondary batteries and lithium ion secondary batteries, a material containing a lithium-containing transition metal oxide as a main component is used for a positive electrode. Further, metal lithium or a lithium alloy is used for a negative electrode. Or alternatively, for example, a material containing a carbonaceous material typified by graphite as a main component is used for the negative electrode. These batteries are referred to as lithium secondary batteries and lithium ion secondary batteries respectively. The positive and negative electrodes are provided with a separator interposed therebetween, and the space between the positive and negative electrodes is filled with a non-aqueous electrolyte solution serving as a medium for migration of Li ions. A solution obtained by dissolving an electrolyte such as lithium hexafluorophosphate (LiPF₆) in a high-permittivity organic solvent such as ethylene carbonate or dimethyl carbonate is widely used as the non-aqueous electrolyte solution. However, such an organic solvent is volatile and flammable and is a solvent classified as a flammable material. Therefore, there is a demand for a nonflammable non-aqueous electrolyte solution for use particularly in large-scale non-aqueous secondary battery applications such as power sources for power storage and power sources for electric automobiles, and attention is given to a technology that uses a flame retardant or self-extinguishing non-aqueous electrolyte solution.

For the purpose of imparting flame retardancy to a non-aqueous electrolyte solution, it is contemplated to add a phosphate known as a flame retardant for resin materials (Patent Literatures 1 and 2). Particularly, a fluorine-containing phosphate having a fluorine atom on its ester side chain is known to have high flame retardancy and is a promising material because such a phosphate provides a wide electrolyte solution composition range in which both the battery function and flame retardancy can be obtained (Non-Patent Literature 1 and Patent Literatures 3, 4, 5, and 6).

When a non-aqueous secondary battery is used as, for example, the power source of an electric automobile, the battery is required not only to be safe but also to have high battery performance. Therefore, the use of a fluorine-containing phosphate having an improved structure is being contemplated. In Patent Literatures 3 and 4, the use of a fluorine-containing phosphate in which the structures at the terminal ends of all the ester groups are CF₃ is contemplated. In Patent Literatures 5 and 6, the use of a fluorine-containing phosphate in which the structures at the terminal ends of all the ester groups are CF₂H is contemplated. However, a battery containing any of the above fluorine-containing phosphates does not have sufficient battery performance such as high-rate charge-discharge characteristics.

To impart higher flame retardancy to a battery, it is desirable that the amount of a low-flash point solvent such as a chain carbonate contained in the electrolyte solution be reduced or such a low-flash point solvent be not used. In such a case, the ability of the fluorine-containing phosphate to dissolve the electrolyte is important to maintain the concentration of the electrolyte in the electrolyte solution. However, the fluorine-containing phosphates in Patent Literatures 3, 4, 5, and 6 are not satisfactory from this point of view.

An example of the synthesis of a fluorine-containing phosphate having both CF₃ and CF₂H as the structures of the terminal ends of ester groups in one molecule has been reported in Non-Patent Literature 2. However, the basic properties, such as viscosity, permittivity, and surface tension required for a non-aqueous electrolyte solution, of the fluorine-containing phosphate having the above specific structure have not been reported, and there are no known non-aqueous electrolyte solutions and non-aqueous secondary batteries that use the above fluorine-containing phosphate.

In addition, no example of the synthesis of an asymmetric fluorine-containing phosphate that has both CF₃ and CF₂H as the structures of the terminal ends of ester groups in one molecule and in which the structures of the three ester side chains are different from each other has been reported.

### CITATION LIST

### Patent Literature

Patent Literature 1: Japanese Patent Application Laid-Open No. Hei 8-22839
Patent Literature 2: Japanese Patent Application Laid-Open No. Hei 11-260401
Patent Literature 3: Japanese Patent Application Laid-Open No. Hei 8-088023
Patent Literature 4: Japanese Patent Application Laid-Open No. 2007-258067
Patent Literature 5: Japanese Patent Application Laid-Open No. 2007-141760
Patent Literature 6: Japanese Patent Application Laid-Open No. 2008-21560

### Non Patent Literature

Non-Patent Literature 1: J. Electrochem. Soc., 149, A1079 (2002)
Non-Patent Literature 2: J. Fluor. Chem., 106, 153 (2000)

### SUMMARY OF INVENTION

### Technical Problems

The present invention has been made in view of the foregoing problems. Accordingly, it is an object to provide a fluorine-containing phosphate used for an electrolyte solution for a non-aqueous secondary battery, particularly a fluorine-containing phosphate having high flame retardancy and providing high battery performance such as high-rate charge-discharge characteristics, a method for manufacturing the same, and a non-aqueous electrolyte solution and a non-aqueous secondary battery that contain the fluorine-containing phosphate.

It is another object to provide a fluorine-containing phosphate having a high ability to dissolve an electrolyte and capable of providing the composition of a safer electrolyte solution.

### Solution to Problem

The present inventors have conducted extensive studies to solve the foregoing problems and found a fluorine-containing phosphate having a specific structure with characteristics suitable for a non-aqueous electrolyte solution, a method for manufacturing the same with a high yield, and a high-performance non-aqueous electrolyte solution and a high-performance non-aqueous secondary battery each containing the fluorine-containing phosphate, and thus the present invention has been completed. Therefore, the gist of the present invention is as follows.

(1) A fluorine-containing phosphate for a non-aqueous electrolyte solution, being represented by the general formula (1)

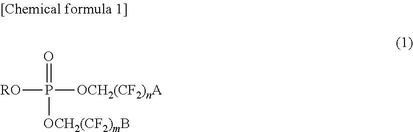

(wherein R represents an alkyl group having 1 to 10 carbon atoms or a fluorine-containing alkyl group having 1 to 10 carbon atoms, A and B are different from each other and each represent a hydrogen atom or a fluorine atom, and n and m each independently represent an integer from 1 to 8) and containing fluorine atoms in a weight ratio of 30% or higher.

(2) The fluorine-containing phosphate for a non-aqueous electrolyte solution according to (1), characterized in that in the general formula (1) n and m are each independently an integer from 1 to 4, and R is an alkyl group having 1 to 4 carbon atoms or a fluorine-containing alkyl group having 1 to 4 carbon atoms.

(3) The fluorine-containing phosphate for a non-aqueous electrolyte solution according to (1), characterized in that in the general formula (1) n and m are each independently an integer from 1 to 4, and R is one selected from a methyl group, an ethyl group, a 2,2-difluoroethyl group, a 2,2,2-trifluoroethyl group, a 2,2,3,3-tetrafluoropropyl group, and a 2,2,3,3,3-pentafluoropropyl group.

(4) The fluorine-containing phosphate for a non-aqueous electrolyte solution according to (1), wherein the compound represented by the general formula (1) is bis(2,2,2-trifluoroethyl) 2,2,3,3-tetrafluoropropyl phosphate.

(5) The fluorine-containing phosphate for a non-aqueous electrolyte solution according to (1), wherein the compound represented by the general formula (1) is bis(2,2,3,3-tetrafluoropropyl) 2,2,2-trifluoroethyl phosphate.

(6) The fluorine-containing phosphate for a non-aqueous electrolyte solution according to (1), wherein the compound represented by the general formula (1) is bis(2,2,2-trifluoroethyl) 2,2-difluoroethyl phosphate.

(7) The fluorine-containing phosphate for a non-aqueous electrolyte solution according to (1), wherein the compound represented by the general formula (1) is methyl 2,2,3,3-tetrafluoropropyl 2,2,2-trifluoroethyl phosphate.

(8) A non-aqueous electrolyte solution containing the fluorine-containing phosphate according to any one of (1) to (7).

(9) A non-aqueous electrolyte solution containing the fluorine-containing phosphate according to any one of (1) to (7) and a lithium salt.

(10) A non-aqueous electrolyte solution containing a lithium salt and an organic solvent containing the fluorine-containing phosphate according to any one of (1) to (7) in a weight ratio of 3 to 60%.

(11) A non-aqueous electrolyte solution containing a lithium salt and an organic solvent containing the fluorine-containing phosphate according to any one of (1) to (7) in a weight ratio of 5 to 40%.

(12) A non-aqueous secondary battery in which the non-aqueous electrolyte solution according to any one of (8) to (11) is used.

(13) A method for manufacturing a fluorine-containing phosphate represented by the general formula (1) through a three-step reaction, the three-step reaction including the steps of

1) reacting phosphorus trichloride with t-butanol, a fluorine-containing alcohol represented by the general formula (2)

A(CF₂)ₙCH₂OH (2)

(wherein A is a hydrogen atom or a fluorine atom, and n is an integer from 1 to 8), and an alcohol represented by the general formula (3)

ROH (3)

(wherein R is an alkyl group having 1 to 10 carbon atoms or a fluorine-containing alkyl group having 1 to 10 carbon atoms) to produce a fluorine-containing phosphite represented by the general formula (4)

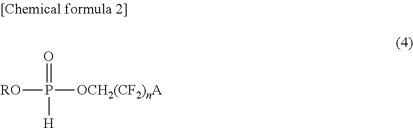

(wherein A, n, and R are as defined above),

2) reacting the fluorine-containing phosphite represented by the general formula (4) with molecular chlorine to produce a fluorine-containing chlorophosphate represented by the general formula (5)

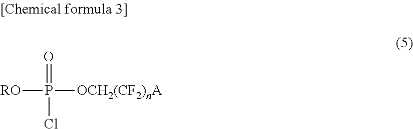

(wherein A, n, and R are as defined above), and

3) reacting the fluorine-containing chlorophosphate represented by the general formula (5) with a fluorine-containing alcohol represented by the general formula (6)

B(CF₂)ₘCH₂OH (6)

(wherein B represents a hydrogen atom or a, fluorine atom, provided that B is different from A in the formula (2), and m represents an integer from 1 to 8) in the presence of a Lewis acid catalyst to thereby produce the fluorine-containing phosphate represented by the general formula (1), wherein, in at least the step 1), a solvent is used in an amount of 0 to 1 times the total amount of raw materials in a weight ratio.

(14) An asymmetric fluorine-containing phosphate, wherein, in the general formula (1), R is different from CH₂(CF₂)ₙA and from CH₂ (CF₂)ₘB.

(15) The asymmetric fluorine-containing phosphate according to (14), wherein the fluorine-containing phosphate represented by the general formula (1) is methyl 2,2,3,3-tetrafluoropropyl 2,2,2-trifluoroethyl phosphate.

### Advantageous Effects of Invention

According to the present invention, a fluorine-containing phosphate for a non-aqueous electrolyte solution that has a specific structure proving high flame retardancy and high-battery performance such as high-rate charge-discharge characteristics and a method of manufacturing the same are provided. A non-aqueous electrolyte solution and a non-aqueous secondary battery each containing the fluorine-containing phosphate and having improved performance are also provided.

In addition, a fluorine-containing phosphate having a high ability to dissolve an electrolyte and capable of providing the composition of a safer electrolyte solution is provided.

### BRIEF DESCRIPTION OF DRAWING

FIG. 1 is a schematic cross-sectional view of a non-aqueous secondary battery used in Examples 18 to 26 and Comparative Examples 6 to 8.

### DESCRIPTION OF EMBODIMENTS

The present invention will next be described in more detail.

A fluorine-containing phosphate of the present invention for a non-aqueous electrolyte solution is represented by the general formula (1) above. More specifically, at least one of the ester side chains has a terminal CF₃ structure, and at least one has a terminal CF₂H structure. The structures of the three ester side chains are different from each other, or two of them are the same. The former is referred to as an asymmetric fluorine-containing phosphate because it has no symmetry plane, and the latter is referred to as a low-symmetric fluorine-containing phosphate because it has only one symmetry plane. In addition, the fluorine-containing phosphate of the present invention contains fluorine atoms in a weight ratio of 30% or higher. A ratio of fluorine atoms in the fluorine-containing phosphate of less than 30 wt % is not preferred because the flame retardancy of a non-aqueous electrolyte solution or non-aqueous secondary battery containing the fluorine-containing phosphate is not satisfactory.

Since the fluorine-containing phosphate has any of the above specific structures, it can provide not only high flame retardancy but also good characteristics as a non-aqueous electrolyte solution. Accordingly, a non-aqueous secondary battery using the fluorine-containing phosphate has high performance such as high-rate charge-discharge characteristics.

Since the fluorine-containing phosphate has any of the above specific structures, its ability to dissolve an electrolyte is significantly improved, and the composition of a highly safe electrolyte solution can be provided.

In the general formula (1), n and m are each independently an integer from 1 to 8. Particularly, n and m are preferably 1 to 4. R is an alkyl group having 1 to 10 carbon atoms or a fluorine-containing alkyl group having 1 to 10 carbon atoms. Particularly, R is preferably an alkyl group having 1 to 4 carbon atoms or a fluorine-containing alkyl group having 1 to 4 carbon atoms. More preferably, R is one selected from a methyl group, an ethyl group, a 2,2-difluoroethyl group, a 2,2,2-trifluoroethyl group, a 2,2,3,3-tetrafluoropropyl group, and a 2,2,3,3,3-pentafluoropropyl group.

Examples of such a fluorine-containing phosphate include bis(2,2,2-trifluoroethyl) 2,2-difluoroethyl phosphate, bis(2,2,2-trifluoroethyl) 2,2,3,3-tetrafluoropropyl phosphate, bis(2,2,2-trifluoroethyl) 2,2,3,3,4,4,5,5-octafluoropentyl phosphate, bis(2,2,2-trifluoroethyl) 2,2,3,3,4,4,5,5,6,6,7,7-dodecafluoroheptyl phosphate, bis(2,2,2-trifluoroethyl) 2,2,3,3,4,4,5,5,6,6,7,7,8,8,9,9-hexadecafluorononyl phosphate, bis(2,2-difluoroethyl) 2,2,2-trifluoroethyl phosphate, bis(2,2,3,3-tetrafluoropropyl) 2,2,2-trifluoroethyl phosphate, bis(2,2,3,3-tetrafluoropropyl) 2,2,3,3,3-pentafluoropropyl phosphate, bis(2,2,3,3-tetrafluoropropyl) 2,2,3,3,4,4,5,5,5-nonafluoropentyl phosphate, bis(2,2,3,3-tetrafluoropropyl) 2,2,3,3,4,4,5,5,6,6,7,7,7-tridecafluoroheptyl phosphate, bis(2,2,3,3-tetrafluoropropyl) 2,2,3,3,4,4,5,5,6,6,7,7,8,8,9,9,9-heptadecafluorononyl phosphate, methyl 2,2-difluoroethyl 2,2,2-trifluoroethyl phosphate, methyl 2,2,3,3-tetrafluoropropyl-2,2,2-trifluoroethyl phosphate, ethyl 2,2,3,3-tetrafluoropropyl 2,2,2-trifluoroethyl phosphate, hexyl 2,2,3,3-tetrafluoropropyl 2,2,2-trifluoroethyl phosphate, octyl 2,2,3,3-tetrafluoropropyl 2,2,2-trifluoroethyl phosphate, and decyl 2,2,3,3-tetrafluoropropyl 2,2,2-trifluoroethyl phosphate. Of these fluorine-containing phosphates, bis(2,2,2-trifluoroethyl) 2,2,3,3-tetrafluoropropyl phosphate, bis(2,2,3,3-tetrafluoropropyl) 2,2,2-trifluoroethyl phosphate, bis(2,2,2-trifluoroethyl) 2,2-difluoroethylphosphate, and methyl 2,2,3,3-tetrafluoropropyl 2,2,2-trifluoroethyl phosphate are particularly preferred in terms of battery performance.

It is desirable that these fluorine-containing phosphates be high purity phosphates. Particularly, it is desirable that the amounts of protic compounds such as water, acids, and alcohols be less than 30 ppm. A single one of or a mixture of at least one of these fluorine-containing phosphates may be used for anon-aqueous electrolyte solution.

A description will next be given of a method for manufacturing the fluorine-containing phosphate having any of the above specific structures. The fluorine-containing phosphate of the present invention represented by the general formula (1) can be synthesized using, for example, any of methods described in J. Fluor. Chem., 113, 65 (2002) and J. Fluor. Chem., 106, 153 (2000), i.e., according to the scheme 1.

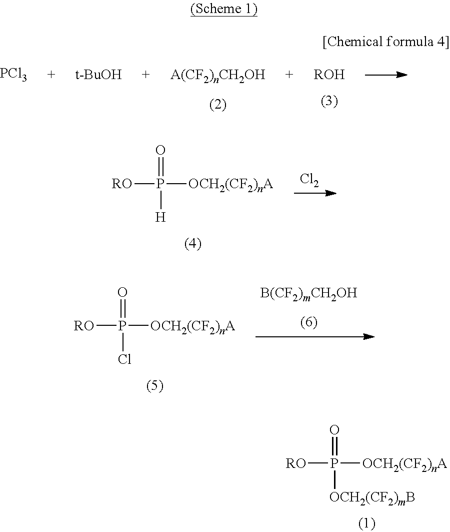

In the above scheme, when the alcohol represented by the general formula (3) is the same as any one of the fluorine-containing alcohols represented by the general formulas (2) and (6), it is a synthesis method of a low-symmetric fluorine-containing phosphate. When the alcohol represented by the general formula (3) is different from the fluorine-containing alcohols represented by the general formulas (2) and (6), it is a synthesis method of an asymmetric fluorine-containing phosphate.

In a first step, A in the fluorine-containing alcohol represented by the general formula (2) represents a hydrogen atom or a fluorine atom, and n represents an integer from 1 to 8. Examples of such a fluorine-containing alcohol include 2,2-difluoroethanol 2,2,2-trifluoroethanol, 2,2,3,3-tetrafluoropropanol, 2,2,3,3,3-pentafluoropropanol, 2,2,3,3,4,4,5,5-octafluoropentanol, 2,2,3,3,4,4,5,5,5-nonafluoropentanol, 2,2,3,3,4,4,5,5,6,6,7,7-dodecafluoroheptanol, 2,2,3,3,4,4,5,5,6,6,7,7,7-tridecafluoroheptanol, 2,2,3,3,4,4,5,5,6,6,7,7,8,8,9,9-hexadecafluorononanol, and 2,2,3,3,4,4,5,5,6,6,7,7,8,8,9,9,9-heptadecafluorononanol. The alcohol represented by the general formula (3) is a fluorine-free or fluorine-containing alcohol having 1 to 10 carbon atoms and is the same as one of the fluorine-containing alcohols represented by the general formulas (2) and (6) or different from them. Examples of the alcohol represented by the general formula (3) include methanol, ethanol, n-propanol, isopropanol, n-butanol, isobutanol, t-butanol, n-hexanol, n-octanol, n-decanol, 2,2-di fluoroethanol, 2,2,2-trifluoroethanol, 2,2,3,3-tetrafluoropropanol, 2,2,3,3,3-pentafluoropropanol, 2,2,3,3,4,4,5,5-octafluoropentanol, 2,2,3,3,4,4,5,5,5-nonafluoropentanol, 2,2,3,3,4,4,5,5,6,6,7,7-dodecafluoroheptanol, 2,2,3,3,4,4,5,5,6,6,7,7,7-tridecafluoroheptanol, 2,2,3,3,4,4,5,5,6,6,7,7,8,8,9,9-hexadecafluorononanol, and 2,2,3,3,4,4,5,5,6,6,7,7,8,8,9,9,9-heptadecafluorononanol.

In the first step, a solvent may be used. The desired solvent is an aprotic solvent, and examples of the aprotic solvent include: alkanes such as hexane and heptane; aromatic hydrocarbons such as benzene and toluene; halogenated hydrocarbons such as dichloromethane and chloroform; ethers such as diethyl ether and tetrahydrofuran; ketones such as acetone and methyl ethyl ketone; esters such as ethyl acetate and butyl acetate; nitriles such as acetonitrile and propionitrile; and amides such as dimethylformamide and dimethylacetamide. Particularly, the present invention is characterized in that, at least in the first step, the amount of the solvent used is 0 to 1 times the total amount of the raw materials including phosphorus trichloride, t-butanol, the fluorine-containing alcohol represented by the general formula (2), and the alcohol represented by the general formula (3) in a weight ratio, so that the fluorine-containing phosphate represented by the general formula (1) is obtained with a high yield.

In the first step, the amount of t-butanol used is 0.5 to 2 times the amount of phosphorus trichloride in a molar ratio, and the amounts of the fluorine-containing alcohol represented by the general formula (2) and the alcohol represented by the general formula (3) are each 0.5 to 4 times the amount of phosphorus trichloride in a molar ratio. The order of mixing the raw materials is not specifically limited. Generally, phosphorus trichloride is mixed with t-butanol, and then the alcohols represented by the general formulas (2) and (3) are added to the mixture. The reaction temperature is −20 to 100° C., and the reaction time is 10 minutes to 100 hours. After completion of the reaction, the produced fluorine-containing phosphite represented by the general formula (4) may be purified or not and then is used in a second step.

In the second step, the fluorine-containing phosphite represented by the general formula (4) and produced in the first step is reacted with molecular chlorine. The same solvent as that used in the first step may also be used in this step. The amount of the solvent used is preferably 0 to 1 times the total amount of the raw materials including the fluorine-containing phosphite represented by the general formula (4) and the molecular chlorine in a weight ratio. The amount of the molecular chlorine used is 0.8 to 2 times the amount of the fluorine-containing phosphite represented by the general formula (4) in a molar ratio. The reaction temperature is −20 to 100° C., and the reaction time is 10 minutes to 100 hours. After completion of the reaction, the produced fluorine-containing chlorophosphate represented by the general formula (5) may be purified or not and then is used in a third step.

In the third step, the fluorine-containing chlorophosphate represented by the general formula (5) and produced in the second step is reacted with the fluorine-containing alcohol represented by the general formula (6) in the presence of a Lewis acid catalyst. The same solvent as that used in the first step may also be used in this step. The amount of the solvent used is preferably 0 to 1 times the total amount of the raw materials including the fluorine-containing chlorophosphate represented by the general formula (5), the Lewis acid, and the fluorine-containing alcohol represented by the general formula (6) in a weight ratio. It is desirable that the Lewis acid catalyst be a metal halide, and examples thereof include lithium chloride, magnesium chloride, calcium chloride, boron chloride, aluminum chloride, iron chloride, and titanium chloride. In the fluorine-containing alcohol represented by the general formula (6), m in the formula represents an integer from 1 to 8, and B represents a fluorine atom or a hydrogen atom. When A in the general formula (2) is a fluorine atom, B in the general formula (6) is a hydrogen atom, and examples of the fluorine-containing alcohol represented by the general formula (6) include 2,2-difluoroethanol, 2,2,3,3-tetrafluoropropanol, 2,2,3,3,4,4,5,5-octafluoropentanol, 2,2,3,3,4,4,5,5,6,6,7,7-dodecafluoroheptanol, and 2,2,3,3,4,4,5,5,6,6,7,7,8,8,9,9-hexadecafluorononanol. When A in the general formula (2) is a hydrogen atom, B in the general formula (6) is a fluorine atom, and examples of the fluorine-containing alcohol represented by the general formula (6) include 2,2,2-trifluoroethanol, 2,2,3,3,3-pentafluoropropanol, 2,2,3,3,4,4,5,5,5-nonafluoropentanol, 2,2,3,3,4,4,5,5,6,6,7,7,7-tridecafluoroheptanol, and 2,2,3,3,4,4,5,5,6,6,7,7,8,8,9,9,9-heptadecafluorononanol. The amount of the Lewis acid catalyst used is 0.01 to 0.5 times the amount of the fluorine-containing chlorophosphate represented by the general formula (5) in a molar ratio. The amount of the fluorine-containing alcohol represented by the general formula (6) used is 0.5 to 2 times the amount of the fluorine-containing chlorophosphate represented by the general formula (5) in a molar ratio. The reaction temperature is −20 to 200° C., and the reaction time is 10 minutes to 100 hours.

After completion of the reaction, the produced fluorine-containing phosphate represented by the general formula (1) can be isolated by any known method such as extraction or distillation.

A description will next be given of a non-aqueous electrolyte solution containing the fluorine-containing phosphate having any of the above specific structures of the present invention and a non-aqueous secondary battery containing the non-aqueous electrolyte solution.

The above-described fluorine-containing phosphate may be used alone as a solvent for an electrolyte or used as a mixture with another organic solvent. In such a case, examples of the organic solvent include: cyclic carbonates such as propylene carbonate, ethylene carbonate, butylene carbonate, chloroethylene carbonate, and fluoroethylene carbonate; cyclic esters such as γ-butyrolactone, γ-valerolactone, and propiolactone; chain carbonates such as dimethyl carbonate, diethyl carbonate, ethyl methyl carbonate, diphenyl carbonate, and bis(2,2,2-trifluoroethyl)carbonate; chain esters such as methyl acetate, methyl butyrate, and trifluoro ethyl acetate; ethers such as diisopropyl ether, tetrahydrofuran, dioxolane, dimethoxyethane, diethoxyethane, methoxyethoxyethane, perfluorobutylmethyl ether, 2,2,2-trifluoroethyl-1,1,2,2-tetrafluoroethyl ether, and 2,2,3,3-tetrafluoropropyl-1,1,2,2-tetrafluoroethyl ether; and nitriles such as acetonitrile and benzonitrile. These may be used alone or as a mixture of two or more. Particularly, when the fluorine-containing phosphate is mixed with any of these solvents, the amount of the fluorine-containing phosphate added is preferably 3 to 60 percent by weight with respect to the amount of the organic solvent, and more preferably 5 to 40 percent by weight. When the added amount in the weight ratio is less than 3%, the flame retardant effect of the electrolyte solution is not satisfactory. The larger the amount added, the higher the flame retardant effect. However, when the added amount in the weight ratio is more than 60%, the battery performance may deteriorate.

As an electrolyte salt used to constitute the non-aqueous electrolyte solution, lithium salts, magnesium salts, and the like can be used because they are stable over a wide potential range. Examples of such an electrolyte salt include LiBF₄, LiPF₆, LiClO₄, LiCF₃SO₃, LiN(CF₃SO₂)₂, LiN(C₂F₆SO₂)₂, LiC(CF₃SO₂)₃, Mg(ClO₄)₂, Mg(CF₃SO₃)₂, and Mg(N(CF₃SO₂)₂)₂. These may be used alone or as a mixture of two or more. To obtain good high-rate charge-discharge characteristics of the battery, the concentration of the electrolyte salt in the non-aqueous electrolyte solution is preferably in the range of 0.5 to 2.5 mol/L.

The non-aqueous secondary battery of the present invention uses the aqueous electrolyte solution having the above composition and includes at least a positive electrode, a negative electrode, and a separator.

For a lithium secondary battery, metal lithium or a lithium alloy, for example, can be used as the material of the negative electrode. For a lithium ion secondary battery, a carbon material that can be doped with lithium ions and de-doped can be used. Such a carbon material may be graphite or amorphous carbon, and any carbon materials such as activated carbon, carbon fibers, carbon black, and mesocarbon microbeads can be used. For a magnesium secondary battery, examples include metal magnesium and magnesium alloys.

Any of transition metal oxides and transition metal sulfides such as MoS₂, TiS₂, MnO₂, and V₂O₅, conductive polymers such as polyaniline and polypyrrole, compounds such as disulfide compounds that can undergo electrolytic polymerization and depolymerization reversibly, composite oxides of lithium and transition metals such as LiCoO₂, LiMnO₂, LiMn₂O₄, LiNiO₂, LiFeO₂, and LiFePO₄, and composite oxides of magnesium and transition metals can be used as the material of the positive electrode.

A fine porous film, for example, is used as the separator. The thickness of the separator is preferably in the range of 10 μm to 20 μm, and the porosity is preferably in the range of 35% to 50%. Examples of the material of the separator include: polyolefin-based resins such as polyethylene and polypropylene; polyester-based resins such as polyethylene terephthalate and polybutylene terephthalate; and fluorine-based resins such as polyvinylidene fluoride, a vinylidene fluoride-tetrafluoroethylene copolymer, a vinylidene fluoride-trifluoroethylene copolymer, and a vinylidene fluoride-ethylene copolymer.

The shape, form, and the like of the non-aqueous secondary battery of the present invention are not especially limited to particular ones. They may be freely selected from cylindrical, rectangular, coin, card, large, and other types within the scope of the present invention.

### EXAMPLES

The present invention will next be described in detail by way of Examples, but the present invention is not limited to these Examples.

### Example 1

### Synthesis of bis(2,2,2-trifluoroethyl) 2,2,3,3-tetrafluoropropyl phosphate

340 g of phosphorus trichloride, 184 g of t-butyl alcohol, and 496 g of 2,2,2-trifluoroethanol were mixed at 0° C., and the mixture was allowed to react at 60° C. for 3 hours. Then the resultant mixture was cooled to 0° C., and 193 g of chlorine gas was blown into the mixture over 6 hours. Next, 9.4 g of magnesium chloride and 409 g of 2,2,3,3-tetrafluoropropanol were added to the reaction mixture, and the resultant mixture was allowed to react at 130° C. for 4 hours. After cooling, 500 g of water and 16 g of sodium hydrogencarbonate were added to the reaction mixture. The resultant mixture was stirred, and the aqueous layer was removed. The organic layer was purified by distillation to obtain 743 g of bis(2,2,2-trifluoroethyl) 2,2,3,3-tetrafluoropropyl phosphate.

¹H-NMR (400 MHz, CDCl₃) δ 5.92 (tt, 1H), 4.39-4.51 (m, 6H)

¹⁹F-NMR (376 MHz, CDCl₃) δ −76.01 (t, 6F), −125.15 (t, 2F), −137.97 (d, 2F)

EI-MS m/z 357 [M-F]⁺, 356 [M-HF]⁺, 275, 245, 225, 165, 163, 143, 115, 95, 83, 69, 64, 51, 33

### Example 2

### Synthesis of bis(2,2,3,3-tetrafluoropropyl) 2,2,2-trifluoroethyl phosphate

340 g of phosphorus trichloride, 184 g of t-butyl alcohol, and 660 μg of 2,2,3,3-tetrafluoropropanol were allowed to react at 0° C., and the resultant mixture was allowed to react at 60° C. for 3 hours. Then the reaction mixture was cooled to 0° C., and 196 g of chlorine gas was blown thereinto over 6 hours. Next, 9.4 g of magnesium chloride and 310 g of 2,2,2-trifluoroethanol were added to the reaction mixture, and the resultant mixture was allowed to react at 130° C. for 4 hours. After cooling, 500 g of water and 16 g of sodium hydrogencarbonate were added to the reaction mixture. The resultant mixture was stirred, and the aqueous layer was removed. The organic layer was purified by distillation to obtain 765 g of bis(2,2,3,3-tetrafluoropropyl) 2,2,2-trifluoroethyl phosphate.

EI-MS m/z 389 [M-F]⁺, 388 [M-HF]⁺, 307, 277, 257, 227, 195, 163, 155, 143, 115, 95, 83, 69, 64, 51, 33

### Example 3

### Synthesis of bis(2,2,2-trifluoroethyl) 2,2-difluoroethyl phosphate

The same procedure as in Example 1 was repeated except that 244 g of 2,2-difluoroethanol was used instead of 409 g of 2,2,3,3-tetrafluoropropanol to thereby obtain 616 g of bis(2,2,2-trifluoroethyl) 2,2-difluoroethyl phosphate.

¹H-NMR (400 MHz, CDCl₃) δ 5.97 (tt, 1H), 4.38-4.46 (m, 4H), 4.23-4.33 (m, 3H)

¹⁹F-NMR (376 MHz, CDCl₃) δ −75.99 (t, 6F), −127.67 (dt, 2F)

EI-MS m/z 307 [M-F]⁺, 306 (M-HF)⁺, 275, 263, 245, 225, 207, 165, 163, 143, 115, 83, 69, 64, 51, 33

### Example 4

### Synthesis of methyl 2,2,3,3-tetrafluoropropyl 2,2,2-trifluoroethyl phosphate

137 g of phosphorus trichloride, 75 g of t-butyl alcohol, 110 g of 2,2,2-trifluoroethanol, and 145 g of 2,2,3,3-tetrafluoropropanol were mixed at 0° C., and the mixture was allowed to react at 60° C. for 5 hours. Then the resultant mixture was cooled to 0° C., and 78 g of chlorine gas was blown into the mixture over 2 hours. Next, 3.8 g of magnesium chloride and 39 g of methanol were added to the reaction mixture, and the resultant mixture was allowed to react at 50° C. for 2 hours. After cooling, 281 g of water and 31 g of sodium hydrogencarbonate were added to the reaction mixture. The resultant mixture was stirred, and the aqueous layer was removed. The organic layer was purified by distillation to obtain 55 g of methyl 2,2,3,3-tetrafluoropropyl 2,2,2-trifluoroethyl phosphate.

¹H-NMR (400 MHz, CDCl₃) δ 5.94 (tt, 1H), 4.35-4.46 (m, 4H), 3.87 (d, 3H)

¹⁹F-NMR (376 MHz, CDCl₃) δ −76.01 (t, 3F), −125.58 (td, 2F), −138.44 (d, 2F)

EI-MS m/z 289 [M-F]⁺, 288 [M-HF]⁺, 258, 257, 207, 177, 127, 117, 97, 79, 69, 64, 51, 33

### Example 5

### Synthesis of bis(2,2,2-trifluoroethyl) 2,2,3,3-tetrafluoropropyl phosphate

A solution containing 340 g of phosphorus trichloride in 650 g of dichloromethane, a solution containing 184 g of t-butyl alcohol in 325 g of dichloromethane, and a solution containing 496 of 2,2,2-trifluoroethanol in 325 g of dichloromethane were mixed at 0° C., and the mixture was allowed to react at 60° C. for 3 hours. Then the resultant mixture was cooled to 0° C., and 193 g of chlorine gas was blown into the mixture over 6 hours. After the solvent was removed under reduced pressure, 9.4 g of magnesium chloride and 409 g of 2,2,3,3-tetrafluoropropanol were added to the concentrated solution, and the resultant mixture was allowed to react at 130° C. for 4 hours. After cooling, 500 g of water and 16 g of sodium hydrogencarbonate were added to the reaction mixture. The resultant mixture was stirred, and the aqueous layer was removed. The organic layer was purified by distillation to obtain 626 g of bis(2,2,2-trifluoroethyl) 2,2,3,3-tetrafluoropropyl phosphate.

### Examples 6 to 9 and Comparative Example 1

### Physical Properties of Fluorine-Containing Phosphates

Viscosity (Ubbelohde viscometer, 20° C.) and permittivity were measured for each of the bis(2,2,2-trifluoroethyl) 2,2,3,3-tetrafluoropropyl phosphate obtained in Example 1, the bis(2,2,3,3-tetrafluoropropyl) 2,2,2-trifluoroethyl phosphate obtained in Example 2, the bis(2,2,2-trifluoroethyl) 2,2-difluoroethyl phosphate obtained in Example 3, the methyl 2,2,3,3-tetrafluoropropyl 2,2,2-trifluoroethyl phosphate obtained in Example 4, and tris(2,2,3,3-tetrafluoropropyl) phosphate used as a comparative fluorine-containing phosphate. The results are shown in Table 1.

The bis(2,2,2-trifluoroethyl) 2,2,3,3-tetrafluoropropyl phosphate, bis(2,2,3,3-tetrafluoropropyl) 2,2,2-trifluoroethyl phosphate, bis(2,2,2-trifluoroethyl) 2,2-difluoroethyl phosphate, and methyl 2,2,3,3-tetrafluoropropyl 2,2,2-trifluoroethyl phosphate of the present invention were found to have improved viscosity and permittivity as compared to those of the tris(2,2,3,3-tetrafluoropropyl) phosphate.

TABLE 1

| | | VISCO- | |
|---|---|---|---|
| | | SITY | |
| | FLUORINE-CONTAINING | 20° C. | PERMIT- |
| | PHOSPHATE | (mPa · s) | TIVITY |
| Example 6 | BIS(2,2,2-TRIFLUOROETHYL) | 10.2 | 9.9 |
| | 2,2,3,3-TETRAFLUOROPROPYL | | |
| | PHOSPHATE | | |
| Example 7 | BIS(2,2,3,3- | 22.6 | 9.3 |
| | TETRAFLUOROPROPYL) | | |
| | 2,2,2-TRIFLUOROETHYL | | |
| | PHOSPHATE | | |
| Example 8 | BIS(2,2,2-TRIFLUOROETHYL) | 7.2 | 33.8 |
| | 2,2-DIFLUOROETHYL | | |
| | PHOSPHATE | | |
| Example 9 | METHYL 2,2,3,3- | 9.6 | 80.4 |
| | TETRAFLUOROPROPYL | | |
| | 2,2,2-TRIFLUOROETHYL | | |
| | PHOSPHATE | | |
| Comparative | TRIS(2,2,3,3- | 50.1 | 8.6 |
| Example 1 | TETRAFLUOROPROPYL) | | |
| | PHOSPHATE | | |

### Examples 10 to 12 and Comparative Examples 2 and 3

### Ability of Fluorine-Containing Phosphate to Dissolve Electrolyte

LiPF₆ was added at 20° C. to each of the bis(2,2,2-trifluoroethyl) 2,2,3,3-tetrafluoropropyl phosphate, bis(2,2,3,3-tetrafluoropropyl) 2,2,2-trifluoroethyl phosphate, bis(2,2,2-trifluoroethyl) 2,2-difluoroethyl phosphate, methyl 2,2,3,3-tetrafluoropropyl 2,2,2-trifluoroethyl phosphate, and comparative fluorine-containing phosphates, i.e., tris(2,2,3,3-tetrafluoropropyl) phosphate and tris(2,2,2-trifluoroethyl) phosphate. Each mixture was stirred at 20° C. for 6 hours to dissolve LiPF₆. Undissolved LiPF₆ was separated by filtration, and the ability to dissolve LiPF₆ was determined by ¹⁹F-NMR analysis of the solution. The results are shown in Table 2.

Each of the low-symmetric and asymmetric fluorine-containing phosphates of the present invention was found to have a significantly improved ability to dissolve the electrolyte as compared to those of the symmetric fluorine-containing phosphates.

TABLE 2

| | | ABILITY TO |
|---|---|---|
| | | DISSOLVE |
| | FLUORINE-CONTAINING | LiPF6 |
| | PHOSPHATE | (g/100 g) |
| Example 10 | BIS(2,2,2-TRIFLUOROETHYL) | 6.8 |
| | 2,2,3,3-TETRAFLUOROPROPYL | |
| | PHOSPHATE | |
| Example 11 | BIS(2,2,2-TRIFLUOROETHYL) | 10.0 |
| | 2,2-DIFLUOROETHYL PHOSPHATE | |
| Example 12 | METHYL 2,2,3,3- | 15.6 |
| | TETRAFLUOROPROPYL | |
| | 2,2,2-TRIFLUOROETHYL PHOSPHATE | |
| Comparative | TRIS (2,2,3,3-TETRAFLUOROPROPYL) | 3.8 |
| Example 2 | PHOSPHATE | |
| Comparative | TRIS(2,2,2-TRIFLUOROETHYL) | 5.3 |
| Example 3 | PHOSPHATE | |

### Examples 13 to 17 and Comparative Examples 4 and 5

### Flame Retardant Performance of Fluorine-Containing Phosphates

The bis(2,2,2-trifluoroethyl) 2,2,3,3-tetrafluoropropyl phosphate was added in an amount of 20 percent by weight to a solution mixture containing ethylene carbonate, dimethyl carbonate, and ethyl methyl carbonate in a volume ratio of 1:1:1. Then LiPF₆ was dissolved in the resultant mixture in a ratio of 1 mol/L, and the mixture was referred to as a non-aqueous electrolyte solution a.

The bis(2,2,2-trifluoroethyl) 2,2,3,3-tetrafluoropropyl phosphate was added in an amount of 10 percent by weight to a solution mixture containing ethylene carbonate, dimethyl carbonate, and ethyl methyl carbonate in a volume ratio of 1:1:1. Then LiPF₆ was dissolved in the resultant mixture in a ratio of 1 mol/L, and the mixture was referred to as a non-aqueous electrolyte solution b.

The bis(2,2,3,3-tetrafluoropropyl) 2,2,2-trifluoroethyl phosphate was added in an amount of 20 percent by weight to a solution mixture containing ethylene carbonate, dimethyl carbonate, and ethyl methyl carbonate in a volume ratio of 1:1:1. Then LiPF₆ was dissolved in the resultant mixture in a ratio of 1 mol/L, and the mixture was referred to as a non-aqueous electrolyte solution c.

The bis(2,2,2-trifluoroethyl) 2,2-difluoroethyl phosphate was added in an amount of 20 percent by weight to a solution mixture containing ethylene carbonate, dimethyl carbonate, and ethyl methyl carbonate in a volume ratio of 1:1:1. Then LiPF₆ was dissolved in the resultant mixture in a ratio of 1 mol/L, and the mixture was referred to as a non-aqueous electrolyte solution d.

The methyl 2,2,3,3-tetrafluoropropyl 2,2,2-trifluoroethyl phosphate was added in an amount of 20 percent by weight to a solution mixture containing ethylene carbonate, dimethyl carbonate, and ethyl methyl carbonate in a volume ratio of 1:1:1. Then LiPF₆ was dissolved in the resultant mixture in a ratio of 1 mol/L, and the mixture was referred to as a non-aqueous electrolyte solution e.

dimethyl 2,2,2-trifluoroethyl phosphate was added in an amount of 20 percent by weight to a solution mixture containing ethylene carbonate, dimethyl carbonate, and ethyl methyl carbonate in a volume ratio of 1:1:1. Then LiPF₆ was dissolved in the resultant mixture in a ratio of 1 mol/L, and the mixture was referred to as a non-aqueous electrolyte solution f.

trimethyl phosphate was added in an amount of 20 percent by weight to a solution mixture containing ethylene carbonate, dimethyl carbonate, and ethyl methyl carbonate in a volume ratio of 1:1:1. Then LiPF₆ was dissolved in the resultant mixture in a ratio of 1 mol/L, and the mixture was referred to as a non-aqueous electrolyte solution g. Test pieces were prepared by impregnating glass filters with the respective electrolytes. Each test piece was subjected to a test flame for 10 seconds. After the test flame was moved away, the manner of combustion was visually observed. The results are shown in Table 3. For each of the non-aqueous electrolyte solutions containing any of the bis(2,2,2-trifluoroethyl) 2,2,3,3-tetrafluoropropyl phosphate, bis(2,2,3,3-tetrafluoropropyl) 2,2,2-trifluoroethyl phosphate, bis(2,2,2-trifluoroethyl) 2,2-difluoroethyl phosphate, and methyl 2,2,3,3-tetrafluoropropyl 2,2,2-trifluoroethyl phosphate of the present invention each containing fluorine in an amount of 30 percent by weight or more, the test piece was not combusted. However, for each of the non-aqueous electrolyte solutions containing any of the dimethyl 2,2,2-trifluoroethyl phosphate and trimethyl phosphate each containing fluorine in an amount of less than 30 percent by weight, the test piece was combusted.

TABLE 3

| | | | RATIO OF | | |
|---|---|---|---|---|---|
| | | | FLUORINE | AMOUNT OF | |
| | | | ATOMS | FLUORINE- | |
| | NON- | | CONTAINED | CONTAINING | |
| | AQUEOUS | | IN FLUORINE- | PHOSPHATE | |
| | ELECTROLYTE | | CONTAINING | ADDED | COMBUSTIBILITY |
| | SOLUTION | FLUORINE-CONTAINING PHOSPHATE | PHOSPHATE | (wt %) | (wt %) |
| Example 13 | a | BIS(2,2,2-TRIFLUOROETHYL) | 50.5 | 20 | NOT |
| | | 2,2,3,3-TETRAFLUOROPROPYL | | | COMBUSTED |
| | | PHOSPHATE | | | |
| Example 14 | b | BIS(2,2,2-TRIFLUOROETHYL) | 50.5 | 10 | NOT |
| | | 2,2,3,3-TETRAFLUOROPROPYL | | | COMBUSTED |
| | | PHOSPHATE | | | |
| Example 15 | c | BIS(2,2,3,3-TETRAFLUOROPROPYL) | 51.2 | 20 | NOT |
| | | 2,2,2-TRIFLUOROETHYL PHOSPHATE | | | COMBUSTED |
| Example 16 | d | BIS(2,2,2-TRIFLUOROETHYL) | 46.6 | 20 | NOT |
| | | 2,2-DIFLUOROETHYL PHOSPHATE | | | COMBUSTED |
| Example 17 | e | METHYL 2,2,3,3- | 43.2 | 20 | NOT |
| | | TETRAFLUOROPROPYL | | | COMBUSTED |
| | | 2,2,2-TRIFLUOROETHYL PHOSPHATE | | | |
| Comparative | f | DIMETHYL 2,2,2-TRIFLUOROETHYL | 27.4 | 20 | COMBUSTED |
| Example 4 | | PHOSPHATE | | | |
| Comparative | g | TRIMETHYL PHOSPHATE | 0 | 20 | COMBUSTED |
| Example 5 | | | | | |

### Examples 18 to 26 and Comparative Examples 6 to 8

### Evaluation of Battery Performance of Non-Aqueous Secondary Batteries Containing Fluorine-Containing Phosphates

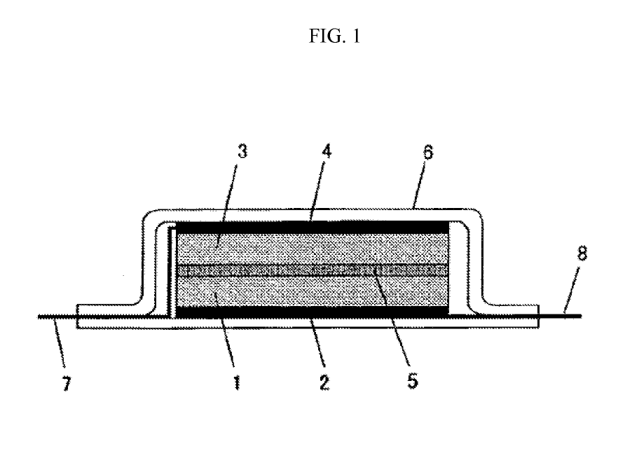

Non-aqueous secondary batteries as shown in the cross-sectional view in FIG. 1 were produced. More specifically, the negative electrode 1 (with a thickness of 0.1 mm) was obtained by coating a current collector 2 made of copper foil with a mixture of graphite, polyvinylidene fluoride, and N-methyl-2-pyrrolidone, drying the coating, and subjecting the product to pressure molding. The positive electrode 3 (with a thickness of 0.1 mm) was obtained by coating a current collector 4 made of copper foil with a mixture of LiCoO₂, acetylene black, and N-methyl-2-pyrrolidone, drying the coating, and subjecting the product to pressure molding. The materials constituting the negative electrode 1 and the positive electrode 3 were stacked with a porous polyethylene separator 5 (with a thickness of 16 μm and a porosity of 50%) interposed therebetween. The bis(2,2,2-trifluoroethyl) 2,2,3,3-tetrafluoropropyl phosphate was mixed in a weight ratio of 20% with a solvent mixture containing ethylene carbonate, dimethyl carbonate, and methyl ethyl carbonate in a volume ratio of 1:1:1 to thereby prepare a solvent. Then LiPF₆ was dissolved in the prepared solvent in a ratio of 1.0 mol/L, and the obtained solution was used as the non-aqueous electrolyte solution of the above-described battery. The material between the positive and negative electrodes was impregnated with the prepared non-aqueous electrolyte solution, and a metal-resin composite film 6 was thermally bonded to seal the product. The obtained non-aqueous secondary battery is referred to as A1.

The bis(2,2,2-trifluoroethyl) 2,2,3,3-tetrafluoropropyl phosphate was mixed in a weight ratio of 10% with a solvent mixture containing ethylene carbonate, dimethyl carbonate, and methyl ethyl carbonate in a volume ratio of 1:1:1 to thereby prepare a solvent. Then LiPF₆ was dissolved in the prepared solvent in a ratio of 1.0 mol/L, and the obtained solution was used as a non-aqueous electrolyte solution. After impregnation with the prepared non-aqueous electrolyte solution, the product was sealed. The obtained non-aqueous secondary battery is referred to as A2.

The bis(2,2,2-trifluoroethyl) 2,2,3,3-tetrafluoropropyl phosphate was mixed in a weight ratio of 30% with a solvent mixture containing ethylene carbonate, dimethyl carbonate, and methyl ethyl carbonate in a volume ratio of 1:1:1 to thereby prepare a solvent. Then LiPF₆ was dissolved in the prepared solvent in a ratio of 1.0 mol/L, and the obtained solution was used as a non-aqueous electrolyte solution. After impregnation with the prepared non-aqueous electrolyte solution, the product was sealed. The obtained non-aqueous secondary battery is referred to as A3.

The bis(2,2,2-trifluoroethyl) 2,2,3,3-tetrafluoropropyl phosphate was mixed in a weight ratio of 50% with a solvent mixture containing ethylene carbonate, dimethyl carbonate, and methyl ethyl carbonate in a volume ratio of 1:1:1 to thereby prepare a solvent. Then LiPF₆ was dissolved in the prepared solvent in a ratio of 1.0 mol/L, and the obtained solution was used as anon-aqueous electrolyte solution. After impregnation with the prepared non-aqueous electrolyte solution, the product was sealed. The obtained non-aqueous secondary battery is referred to as A4.

The bis(2,2,2-trifluoroethyl) 2,2,3,3-tetrafluoropropyl phosphate was mixed in a weight ratio of 30% with a solvent mixture containing ethylene carbonate and 2,2,3,3-tetrafluoropropyl-1,1,2,2-tetrafluoroethyl ether in a volume ratio of 2:1 to thereby prepare a solvent. Then LiPF₆ was dissolved in the prepared solvent in a ratio of 1.0 mol/L, and the obtained solution was used as a non-aqueous electrolyte solution. After impregnation with the prepared non-aqueous electrolyte solution, the product was sealed. The obtained non-aqueous secondary battery is referred to as A5.

The bis(2,2,3,3-tetrafluoropropyl) 2,2,2-trifluoroethyl phosphate was mixed in a weight ratio of 20% with a solvent mixture containing ethylene carbonate, dimethyl carbonate, and methyl ethyl carbonate in a volume ratio of 1:1:1 to thereby prepare a solvent. Then LiPF₆ was dissolved in the prepared solvent in a ratio of 1.0 mol/L, and the obtained solution was used as anon-aqueous electrolyte solution. After impregnation with the prepared non-aqueous electrolyte solution, the product was sealed. The obtained non-aqueous secondary battery is referred to as B.

The bis(2,2,2-trifluoroethyl) 2,2-difluoroethyl phosphate was mixed in a weight ratio of 20% with a solvent mixture containing ethylene carbonate, dimethyl carbonate, and methyl ethyl carbonate in a volume ratio of 1:1:1 to thereby prepare a solvent. Then LiPF₆ was dissolved in the prepared solvent in a ratio of 1.0 mol/L, and the obtained solution was used as a non-aqueous electrolyte solution. After impregnation with the prepared non-aqueous electrolyte solution, the product was sealed. The obtained non-aqueous secondary battery is referred to as C1.

The bis(2,2,2-trifluoroethyl) 2,2-difluoroethyl phosphate was mixed in a weight ratio of 30% with a solvent mixture containing ethylene carbonate and 2,2,2-trifluoroethyl-1,1,2,2-tetrafluoroethyl ether in a volume ratio of 2:1 to thereby prepare a solvent. Then LiPF₆ was dissolved in the prepared solvent in a ratio of 1.0 mol/L, and the obtained solution was used as a non-aqueous electrolyte solution. After impregnation with the prepared non-aqueous electrolyte solution, the product was sealed. The obtained non-aqueous secondary battery is referred to as C2.

The methyl 2,2,3,3-tetrafluoropropyl 2,2,2-trifluoroethyl phosphate was mixed in a weight ratio of 20% with a solvent mixture containing ethylene carbonate, dimethyl carbonate, and methyl ethyl carbonate in a volume ratio of 1:1:1 to thereby prepare a solvent. Then LiPF₆ was dissolved in the prepared solvent in a ratio of 1.0 mol/L, and the obtained solution was used as anon-aqueous electrolyte solution. After impregnation with the prepared non-aqueous electrolyte solution, the product was sealed. The obtained non-aqueous secondary battery is referred to as D.

tris(2,2,2-trifluoroethyl) phosphate was mixed in a weight ratio of 20% with a solvent mixture containing ethylene carbonate, dimethyl carbonate, and methyl ethyl carbonate in a volume ratio of 1:1:1 to thereby prepare a solvent. Then LiPF₆ was dissolved in the prepared solvent in a ratio of 1.0 mol/L, and the obtained solution was used as a non-aqueous electrolyte solution. After impregnation with the prepared non-aqueous electrolyte solution, the product was sealed. The obtained non-aqueous secondary battery is referred to as E.

tris(2,2,3,3-tetrafluoropropyl) phosphate was mixed in a weight ratio of 20% with a solvent mixture containing ethylene carbonate, dimethylcarbonate, and methylethylcarbonate in a volume ratio of 1:1:1 to thereby prepare a solvent. Then LiPF₆ was dissolved in the prepared solvent in a ratio of 1.0 mol/L, and the obtained solution was used as a non-aqueous electrolyte solution. After impregnation with the prepared non-aqueous electrolyte solution, the product was sealed. The obtained non-aqueous secondary battery is referred to as F1.

tris(2,2,3,3-tetrafluoropropyl) phosphate was mixed in a weight ratio of 30% with a solvent mixture containing ethylene carbonate and 2,2,2-trifluoroethyl-1,1,2,2-tetrafluoroethyl ether in a volume ratio of 1:1 to thereby prepare a solvent. To prepare a non-aqueous electrolyte solution, LiPF₆ was dissolved in the prepared solvent in a ratio of 1.0 mol/L. However, the LiPF₆ was not dissolved, and a large amount of precipitates were formed. The ability of such a symmetric fluorine-containing phosphate to dissolve LiPF₆ is not sufficient. Therefore, when the low-flash point chain carbonates used as low-viscosity solvents were replaced with the nonflammable fluorine-containing ether to further improve safety, it was difficult to prepare an electrolyte solution.

The initial discharge capacity and high-rate discharge capacity of each of the non-aqueous secondary batteries A1, A2, A3, A4, A5, B, C1, C2, and D of the present invention and the comparative non-aqueous secondary batteries E and F1 were measured. The initial discharge capacity was determined by performing constant-voltage and constant-current charge with a current of 10 mA and a final voltage of 4.2 V at 20° C. and then performing constant-current discharge with a current of 2 mA and a final voltage of 2.7 V at 20° C. The high-rate discharge capacity was determined by per forming constant-voltage and constant-current charge with a current of 10 mA and a final voltage of 4.2 V at 20° C. and then performing constant-current discharge with a current of 30 mA and a final voltage of 2.7 Vat 20° C. The results are shown in Table 4. Each non-aqueous secondary battery of the present invention containing a fluorine-containing phosphate having a specific structure in the electrolyte solution exhibited a high high-rate discharge capacity.

TABLE 4

| | | | | | INITIAL | HIGH-RATE |
|---|---|---|---|---|---|---|
| | NON-AQUEOUS | | AMOUNT | | DISCHARGE | DISCHARGE |
| | SECONDARY | | MIXED | | CAPACITY | CAPACITY |
| | BATTERY | FLUORINE-CONTAINING PHOSPHATE | (wt %) | SOLVENT | (mAh) | (mAh) |
| Example 18 | A1 | BIS(2,2,2-TRIFLUOROETHYL) | 20 | EC-DMC-EMC | 9.8 | 7.7 |
| | | 2,2,3,3-TETRAFLUOROPROPYL | | (1:1:1) | | |
| | | PHOSPHATE | | | | |
| Example 19 | A2 | BIS(2,2,2-TRIFLUOROETHYL) | 10 | EC-DMC-EMC | 9.9 | 7.9 |
| | | 2,2,3,3-TETRAFLUOROPROPYL | | (1:1:1) | | |
| | | PHOSPHATE | | | | |
| Example 20 | A3 | BIS(2,2,2-TRIFLUOROETHYL) | 30 | EC-DMC-EMC | 9.6 | 7.5 |
| | | 2,2,3,3-TETRAFLUOROPROPYL | | (1:1:1) | | |
| | | PHOSPHATE | | | | |
| Example 21 | A4 | BIS(2,2,2-TRIFLUOROETHYL) | 50 | EC-DMC-EMC | 9.3 | 7.0 |
| | | 2,2,3,3-TETRAFLUOROPROPYL | | (1:1:1) | | |
| | | PHOSPHATE | | | | |
| Example 22 | A5 | BIS(2,2,2-TRIFLUOROETHYL) | 30 | EC-TFPTFEE | 9.3 | 6.9 |
| | | 2,2,3,3-TETRAFLUOROPROPYL | | (2:1) | | |
| | | PHOSPHATE | | | | |
| Example 23 | B | BIS(2,2,3,3-TETRAFLUOROPROPYL) | 20 | EC-DMC-EMC | 9.6 | 7.4 |
| | | 2,2,2-TRIFLUOROETHYL PHOSPHAE | | (1:1:1) | | |
| Example 24 | C1 | BIS(2,2,2-TRIFLUOROETHYL) | 20 | EC-DMC-EMC | 9.9 | 7.9 |
| | | 2,2-DIFLUOROETHYL PHOSPHATE | | (1:1:1) | | |
| Example 25 | C2 | BIS(2,2,2-TRIFLUOROETHYL) | 30 | EC-TFETFEE | 9.5 | 7.1 |
| | | 2,2-DIFLUOROETHYL PHOSPHAE | | (2:1) | | |
| Example 26 | D | METHYL 2,2,3,3-TETRAFLUOROPROPYL | 20 | EC-DMC-EMC | 9.8 | 7.9 |
| | | 2,2,2-TRIFLUOROETHYL PHOSPHATE | | (1:1:1) | | |
| Comparative | E | TRIS(2,2,2-TRIFLUOROETHYL) | 20 | EC-DMC-EMC | 9.5 | 6.9 |
| Example 6 | | PHOSPHATE | | (1:1:1) | | |
| Comparative | F1 | TRIS(2,2,3,3-TETRAFLUOROPROPYL) | 20 | EC-DMC-EMC | 9.4 | 6.7 |
| Example 7 | | PHOSPHATE | | (1:1:1) | | |

| | | | | | |
|---|---|---|---|---|---|
| Comparative | F2 | TRIS(2,2,3,3-TETRAFLUOROPROPYL) | 30 | EC-TFETFEE | LiPF6 PRECIPITATED |
| Example 8 | | PHOSPHATE | | (2:1) | |

TFPTFEE: 2,2,3,3-TETRAFLUOROPROPYL-1,1,2,2-TETRAFLUOROETHYL ETHER
TFETFEE: 2,2,2-TRIFLUOROETHYL-1,1,2,2-TETRAFLUOROETHYL ETHER

The non-aqueous secondary battery C1 of the present invention and the comparative non-aqueous secondary battery E were subjected to a battery cycle life test. More specifically, constant-voltage and constant-current charge with a current of 2 mA and a final voltage of 4.2 V and constant-current discharge with a current of 2 mA and a final voltage of 2.7 were repeated 200 times.

For the non-aqueous secondary battery C of the present invention, the ratio of the 200th discharge capacity to the initial discharge capacity (capacity retention) was 94%.

For the comparative non-aqueous secondary battery F, the ratio of the 200th discharge capacity to the initial discharge capacity (capacity retention) was 89%.

These results showed that the non-aqueous secondary battery of the present invention had not only high high-rate charge-discharge characteristics but also an improved and favorable cycle life.

### INDUSTRIAL APPLICABILITY

The addition of the fluorine-containing phosphate having a specific structure of the present invention to a non-aqueous electrolyte solution allows a non-aqueous secondary battery having improved battery characteristics such as high-rate charge-discharge characteristics to be obtained, and this is very useful.

### REFERENCE SIGNS LIST

1: negative electrode
2: current collector
3: positive electrode
4: current collector
5: porous polyethylene separator
6: metal-resin composite film
7: positive electrode terminal
8: negative electrode terminal

1. A fluorine-containing phosphate for a non-aqueous electrolyte solution, being represented by the general formula (1), 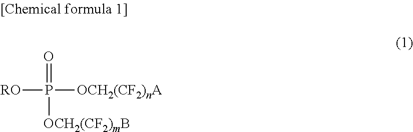
(wherein R represents an alkyl group having 1 to 10 carbon atoms or a fluorine-containing alkyl group having 1 to 10 carbon atoms, A and B are different from each other and each represent a hydrogen atom or a fluorine atom, and n and m each independently represent an integer from 1 to 8) and containing fluorine atoms in a weight ratio of 30% or higher.

2. The fluorine-containing phosphate for a non-aqueous electrolyte solution according to claim 1, characterized in that in the general formula (1) n and m are each independently an integer from 1 to 4, and R is an alkyl group having 1 to 4 carbon atoms or a fluorine-containing alkyl group having 1 to 4 carbon atoms.

3. The fluorine-containing phosphate for a non-aqueous electrolyte solution according to claim 1, characterized in that in the general formula (1) n and m are each independently an integer from 1 to 4, and R is one selected from a methyl group, an ethyl group, a 2,2-difluoroethyl group, a 2,2,2-trifluoroethyl group, a 2,2,3,3-tetrafluoropropyl group, and a 2,2,3,3,3-pentafluoropropyl group.

4. The fluorine-containing phosphate for a non-aqueous electrolyte solution according to claim 1, wherein the compound represented by the general formula (1) is bis(2,2,2-trifluoroethyl) 2,2,3,3-tetrafluoropropyl phosphate.

5. The fluorine-containing phosphate for a non-aqueous electrolyte solution according to claim 1, wherein the compound represented by the general formula (1) is bis(2,2,3,3-tetrafluoropropyl) 2,2,2-trifluoroethyl phosphate.

6. The fluorine-containing phosphate for a non-aqueous electrolyte solution according to claim 1, wherein the compound represented by the general formula (1) is bis(2,2,2-trifluoroethyl) 2,2-difluoroethyl phosphate.

7. The fluorine-containing phosphate for a non-aqueous electrolyte solution according to claim 1, wherein the compound represented by the general formula (1) is methyl 2,2,3,3-tetrafluoropropyl 2,2,2-trifluoroethyl phosphate.

8. A non-aqueous electrolyte solution containing the fluorine-containing phosphate according to claim 1.

9. A non-aqueous electrolyte solution containing the fluorine-containing phosphate according to claim 1 and a lithium salt.

10. A non-aqueous electrolyte solution containing a lithium salt and an organic solvent containing the fluorine-containing phosphate according to claim 1 in a weight ratio of 3 to 60%.

11. A non-aqueous electrolyte solution containing a lithium salt and an organic solvent containing the fluorine-containing phosphate according to claim 1 in a weight ratio of 5 to 40%.

12. A non-aqueous secondary battery in which the non-aqueous electrolyte solution according to claim 8 is used.

13. A method for manufacturing a fluorine-containing phosphate represented by the general formula (1) through a three-step reaction, the three-step reaction including the steps of:
1) reacting phosphorus trichloride with t-butanol, a fluorine-containing alcohol represented by the general formula (2)
A(CF₂)ₙCH₂OH (2)
(wherein A is a hydrogen atom or a fluorine atom, and n is an integer from 1 to 8), and an alcohol represented by the general formula (3)
ROH (3)
(wherein R is an alkyl group having 1 to 10 carbon atoms or a fluorine-containing alkyl group having 1 to 10 carbon atoms) to produce a fluorine-containing phosphite represented by the general formula (4) 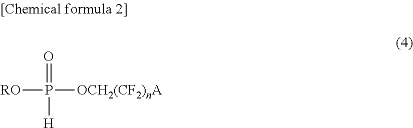
(wherein A, n, and R are as defined above),
2) reacting the fluorine-containing phosphite represented by the general formula (4) with molecular chlorine to produce a fluorine-containing chlorophosphate represented by the general formula (5) 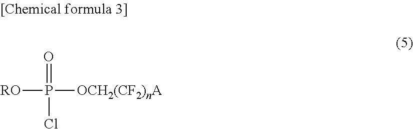
(wherein A, n, and R are as defined above), and
3) reacting the fluorine-containing chlorophosphate represented by the general formula (5) with a fluorine-containing alcohol represented by the general formula (6)
B(CF₂)ₘCH₂OH (6)
(wherein B represents a hydrogen atom or a fluorine atom, provided that B is different from A in the formula (2), and m represents an integer from 1 to 8) in the presence of a Lewis acid catalyst to thereby produce the fluorine-containing phosphate represented by the general formula (1), the method characterized in that, in at least the step 1), a solvent is used in an amount of 0 to 1 times the total amount of raw materials in a weight ratio.

14. An asymmetric fluorine-containing phosphate, wherein in the general formula (1) R is different from CH₂(CF₂)ₙA and from CH₂(CF₂)ₘB.

15. The asymmetric fluorine-containing phosphate according to claim 14, wherein the fluorine-containing phosphate represented by the general formula (1) is methyl 2,2,3,3-tetrafluoropropyl 2,2,2-trifluoroethyl phosphate.
